(19) United States
(12) Patent Application Publication
(10) Pub. No.: US 2012/0060105 A1
(43) Pub. Date: Mar. 8, 2012

(54) SOCIAL NETWORK NOTIFICATIONS

(75) Inventors: Jared A. Brown, Kirkland, WA (US); Monica Estela Gonzalez Veron, Seattle, WA (US); Jannes Paul Peters, Seattle, WA (US); Adam E. Barrus, Redmond, WA (US); Albert Shen, Seattle, WA (US); Michael R. Ducker, Seattle, WA (US); Gokul P. Thirumalai, Mountain View, CA (US); Ryan M. Haning, Issaquah, WA (US); Karen L. Davis, Seattle, WA (US)

(73) Assignee: MICROSOFT CORPORATION, Redmond, WA (US)

(21) Appl. No.: 12/877,740

(22) Filed: Sep. 8, 2010

(51) Int. Cl. G06F 3/01; G06F 15/16

(52) U.S. Cl. 715/753

(57) ABSTRACT

Social network notifications are described. In implementations, a notification is received at a client device from a social network service that includes content that is posted for access via the social network service and includes an identifier of an originator of the posting. The notification is output by the client device to include the content from the posting and the identifier of the originator of the posting.

Social network services continue to increase in popularity. For example, users may leverage a social network service to find and interact with other users, such as friends, business contacts, and so on. This interaction may be performed in a variety of ways, such as through messaging, photo sharing, posting videos, and so on.

However, traditional techniques that were developed to notify users of interaction were sparse and difficult to decipher. For example, a user may receive a notification that interaction has occurred via the social network service, but was traditionally forced to initiate another application to determine what interaction has occurred. Therefore, the user is forced to engage in a time consuming process of launching applications and navigating to the social network service for the user to determine whether the interaction is relevant. The frustration caused by these traditional techniques may cause the user to forgo interaction with the social network service altogether.

### SUMMARY

Social network notifications are described. In implementations, a notification is received at a client device from a social network service that includes content that is posted for access via the social network service and includes an identifier of an originator of the posting. The notification is output by the client device to include the content from the posting and the identifier of the originator of the posting.

In implementations, a communication is received at a social network service that includes content that is to be posted for access via the social network service. A notification is configured to include the content from the communication and an identifier of an originator of the communication. The notification having the content and the identifier is transmitted for receipt by one or more users of the social network service.

In implementations, a client device includes one or more modules that are configured to perform operations comprising displaying one or more notifications received from a social network service in a user interface, the notifications sent to the client device due to an indication that a user of the client device is a friend of an originator of a communication that initiated the notification, the one or more notifications that are displayed are filtered for display based on a likely relevancy of the notification to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform social network service notification techniques.

FIG. 2 is an illustration of an example notification as displayed by a client device of FIG. 1 in which the notification describes a comment made to another user's status message.

FIG. 3 is an illustration of an example notification as displayed by the client device of FIG. 1 in which the notification describes a response to a status message of a user.

FIG. 4 is an illustration of an example notification as displayed by the client device of FIG. 1 in which the notification describes a response to a photo posted by the user of the client device via the social network service.

FIG. 5 is an illustration of an example notification as displayed by the client device of FIG. 1 in which the notification describes a response to a photo posted by another user via the social network service.

FIG. 6 depicts a system in an example implementation in which content included in notifications is leveraged by a filter module to filter which notifications are to be output by the client device of FIG. 1.

FIG. 7 depicts a system in an example implementation in which a single representation is provided of notifications that involve a matching conversation.

FIG. 8 is a flow diagram depicting a procedure in an example implementation in which notification techniques are utilized to provide additional information to a user regarding interaction with a social network service.

### DETAILED DESCRIPTION

Overview

Users of a social network service may share a variety of different content to interact in a variety of different ways. However, traditional techniques that were employed to notify users of this interaction were limited and therefore forced the user to navigate to the social network service to determine what interaction had occurred. This often led to user frustration as the user could not determine the relevancy of the interaction without performing this navigation.

Social network notification techniques are described. In an implementation, notifications provided by a social network service are configured to describe an action that caused generation of the notification, such as interaction with the social network service. In this way, a user may readily determine a cause of the notification and therefore determine whether further interaction with the social network service is desired without actually navigating to the social network service. Further discussion of the notification techniques may be found in relation to the following sections.

In the following discussion, an example environment is first described that is operable to perform social network notification techniques. Example procedures are then described which may be employed by the example environment. However, it should be readily apparent that the example environment is not limited to performing the example techniques and the example techniques are not limited to performance in the example environment.

Example Environment

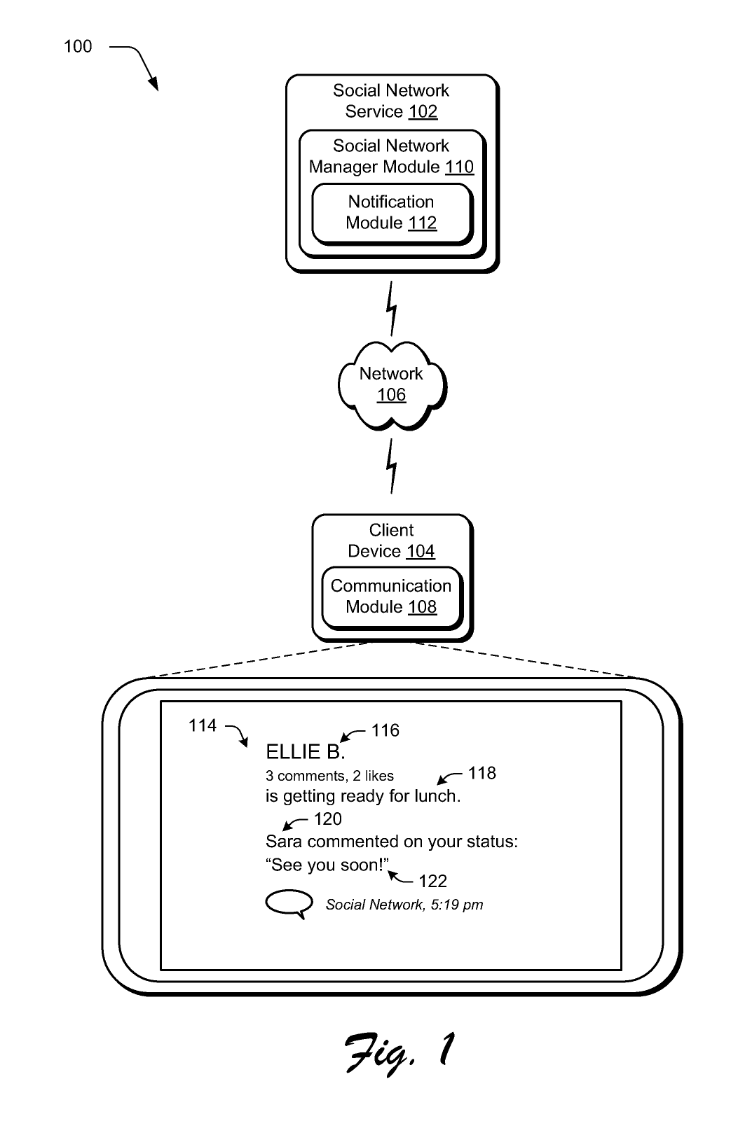

FIG. 1 is an illustration of an environment 100 in an example implementation that is operable to employ notification techniques in a social network service. The illustrated environment 100 includes a social network service 102 and a client device 104 each of which are communicatively coupled, one to another, over a network 106.

The client device 104 may be configured in a variety of ways. For example, the client device 104 may be configured as a computing device that is capable of communicating over the network 106, such as a desktop computer, a mobile station, an entertainment appliance, a set-top box communicatively coupled to a display device, a wireless phone, a game console, and so forth. Thus, the client device 104 may range from a full resource device with substantial memory and processor resources (e.g., personal computers, game consoles) to a low-resource device with limited memory and/or processing resources (e.g., traditional set-top boxes, hand-held game consoles). The client device 104 may also relate to an entity that operates the client device 104, e.g., software.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client device 104 is illustrated as including a communication module 108. The communication module 108 is representative of functionality of the client device 104 to communicate via the network 106. For example, the communication module 108 may include browser functionality to interact with the social network service 102 via the network 106.

The social network service 102 may support a variety of different functionality which is represented by the social network manager module 110. Through the social network manager module 110, for instance, the social network service 102 may support communication of status updates between the client device 104 and another client device that have been specified as friends of each other. Additionally, the specified “friendship” of the social network service 102 may be used as a basis to permit sharing of photos, video, blogs, and so on. Thus, the social network service 102 may use the friend relationship as a technique to permit or restrict access to content associated with a user's account of the social network service 102.

For instance, the client device 102 may be associated with a user's account of the social network service 102. Through this user account, the client device 104 may be used to specify a friend, such as a user account of the social network service 102 that is accessible via another client device. By doing this, the other client device is permitted to access content associated with the client device 104, such as content associated with an account of the social network service 102 of a user of the client device 104 that provided credentials to access the user account. Although a permission system involving friends has been described, it should be readily apparent that the social network service 102 may be configured in a variety of ways to support communication between users. For example, the social network manager module 110 may support blogging and micro-blogging (e.g., having a limited number of characters such as 140) to communicate status updates to subscribers of a particular user, e.g., via the social network service 102 (e.g., an email), via a SMS, and so on.

The social network service 102, and more particularly the social network manager module 110, is also illustrated as including a notification module 112 that is representative of functionality regarding notifications. For instance, the notification module 112 may be representative of functionality regarding notification of interactions performed via the social network service 102. Although the notification module 112 is illustrated as a part of the social network service 102, the notification module 112 may be implemented in a variety of ways, such as part of a third-party service “in the cloud,” as part of the client device 104, and so on.

For example, user-generated content may be originated by another client device and uploaded to the social network service 102 for dissemination. The user-generated content 122 may take a variety of forms, such as a message (e.g., email), posting, status update, and so on. Responsive to this communication (or attempt to do so) of the user-generated content, the notification module 112 may form a notification 114 to be communicated to and displayed by the client device 104. This notification 114 may be configured in a variety of ways.

In the illustrated example, the notification 114 involves an original status message and a follow up comment. Accordingly, in this example the notification 114 identifies a sender 116 of the original status message (e.g., “Ellie B.”) and the content 118 of the status message (e.g., “is getting ready for lunch”). Thus, the originating content is identified in the notification 114.

The notification 114 also includes a follow-up comment to the status message, which also identifies a user 120 who provided the comment (e.g., “Sara”) and the content 122 of the comment (e.g., “See you soon!”). Thus, the notification 114 may readily inform a user of the client device 104 regarding an action taken with respect to the social network service 102 without requiring the user to navigate to the social network service 102.

The notification 114 may also be configured to facilitate navigation to the social network service 102 should the user decide that the notification 114 is relevant, such as by selecting the notification to view additional comments and “likes” that pertain to the subject matter of the notification, i.e., the status message in this example. As illustrated, the notification 114 may indicate a number of other comments, likes, and so on that are not represented in the notification 114 and thus may inform a user that navigation may be performed to view this information if desired.

In another example, the notification may support the ability to respond to the action that generated the notification without having to navigate to the social network 102, therefore allowing the user to stay in-context to their previous task. The notification may take a variety of different forms, examples of which are described in relation to the following figures.

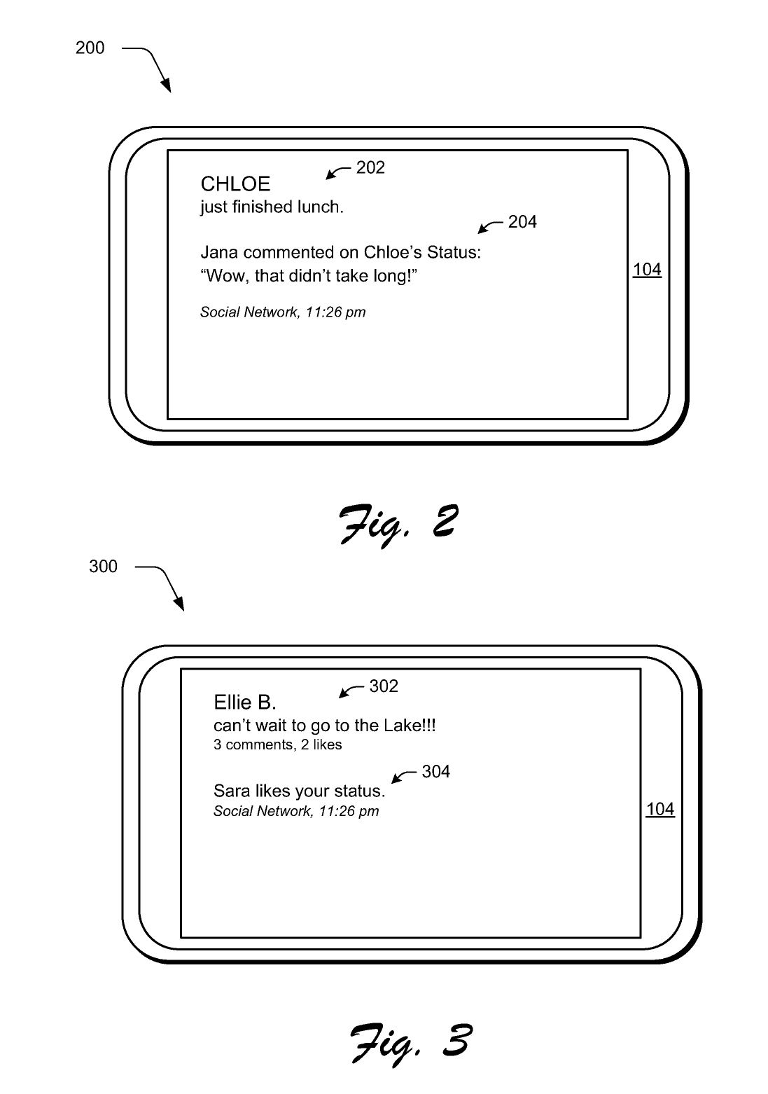

FIG. 2 depicts an example notification 200 as displayed by the client device 104 of FIG. 1 in which the notification 200 describes a comment made to another user's status message. In the notification 114 of FIG. 1, another user (e.g., Sara) commented on a user's (e.g., Ellie) personal status message and thus the originating user was informed as to content that was related to the user's own personal status message.

In the notification 200 of FIG. 2, however, the user receiving the notification 200 did not originate the content that is the subject of the notification 200. Instead, another user (e.g., Chloe) provided a status message 202 that stated that she “just finished lunch.” A comment 204 to that status message resulted in formation and communication of the notification 200, which in this instance the comment 304 originated from another user (e.g., “Jana”). This notification 200 may be sent to the user for a variety of different reasons, e.g., because the user has previously comment on this status message, indicated that the user “liked” the status message, subscribed to a feed of status messages from this user, and so on.

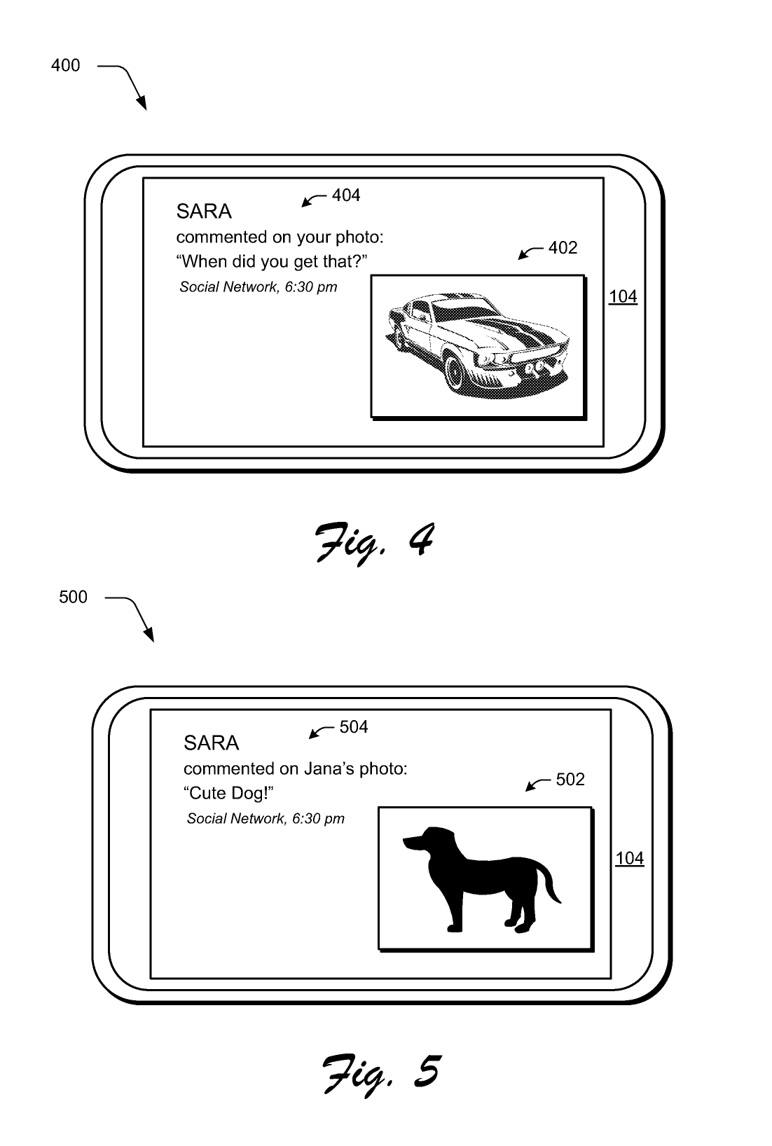

FIG. 3 depicts an example notification 300 as displayed by the client device 104 of FIG. 1 in which the notification 300 describes a response to a status message of a user. In this example, the notification 300 includes content from an original status message 302 “Ellie B. can't wait to go to the Lake!!!” The notification 300 also includes a most recent response to the status message 302, which in this instance is an indication 304 that “Sara likes your status.” The content of other responses in this example are not included in the notification 300, but rather a count is given that may inform a user as to how many responses were received, which in this instance indicates “3 comments” and “2 likes.” Selection of the notification 300 (e.g., the count) may cause the client device 104 to navigate to the social network service 102 via the network 106 to view the other related content. Although status messages have been described in relation to FIGS. 1-3, the notification may be configured in a variety of different ways as well as include a variety of different content, further examples of which may be found in relation to the following figures.

FIG. 4 depicts an example notification 400 as displayed by the client device 104 of FIG. 1 in which the notification 400 describes a response to a photo posted by the user of the client device 104 via the social network service 102. In this example, a photo 402 was posted by a user (e.g., Ellie) of the client device 104 to the social network service 102 for viewing by other users (e.g., “friends) of the service.

The social network service 102 may then receive a comment regarding the photo 402 and therefore cause the notification 400 to be sent to the user that posted the photo 402. The notification 400 in this instance includes the posted content (e.g., the photo 402) as well as the comment 404, which includes an identification of the originator of the comment (e.g., “Sara”) as well as content of the comment 404 (e.g., “When did you get that?”). In this way, a user is given both the comment and a context for the comment.

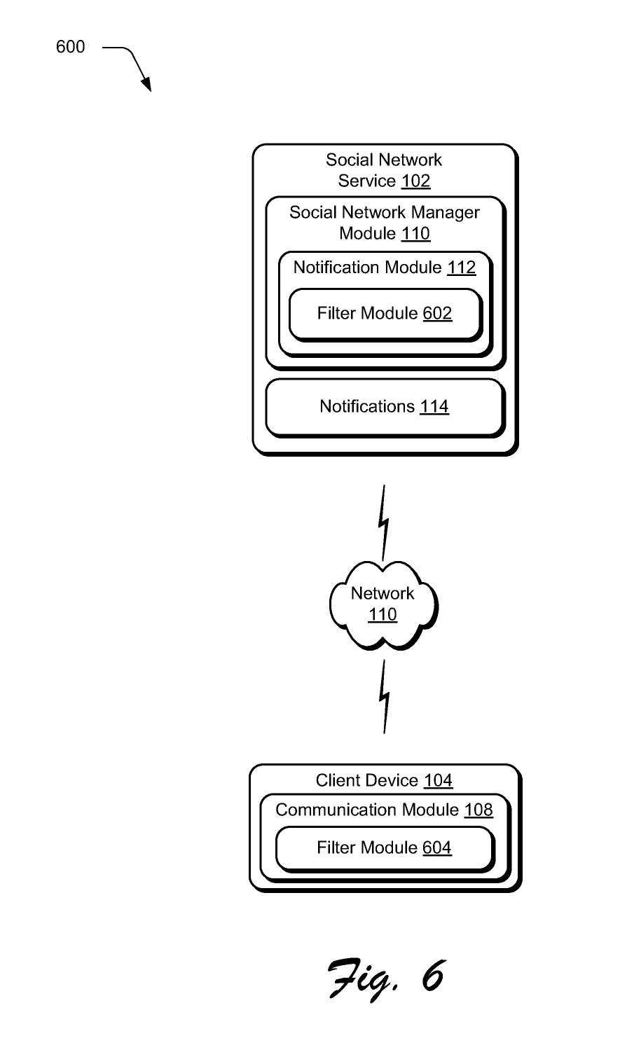

FIG. 5 depicts an example notification 500 as displayed by the client device 104 of FIG. 1 in which the notification 500 describes a response to a photo posted by another user via the social network service. In this example, another user (e.g., Jana) uploaded a photo 502 for viewing by friends in the social network service 102. Yet another user (e.g., Sara) has commented on the photo. Accordingly, the notification 500 is configured in this instance to include the content (e.g., the photo 502) and the comment 504, which also identifies the user (e.g., Sara) that originated the comment 504. As before, this notification 500 may be communicated to the client device 104 by the notification module 112 in response to a variety of actions, such as due to interest in the subject expressed by a user of the client device through comments, “likes,” and so on.

Similar notification techniques may be employed to a variety of actions that may be undertaken in conjunction with the social network service 102. For example, notifications may be configured to include an indication that a particular user has “posted something to your wall” or even “commented on a post to another person's wall.” Likewise, notifications may be configured to indicate “likes” as previously described, “@” replies in micro-blogs, photos in which a user has been tagged, and so on. Thus, in these examples the notifications have been configured to include additional information to inform a user as to relevancy of an action that prompted the notification. This additional information may also be leveraged for other purposes, such as to filter notifications as further described in relation to the following figure.

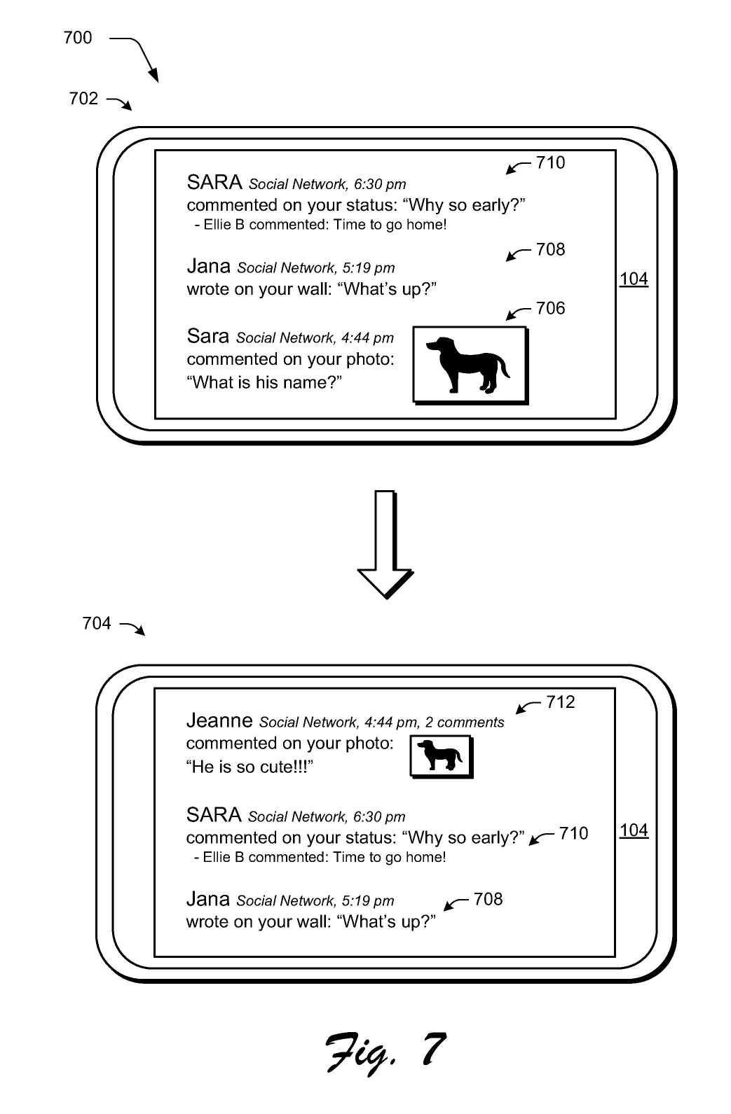

FIG. 6 depicts a system 600 in an example implementation in which content included in notifications is leveraged by a filter module to filter which notifications are to be output by the client device 104. As before, the social network service 102 includes a social network manager module 110 that includes a notification module 112 that is representative of functionality to configure notifications 114 for receipt by a client device, such as the client device 104.

The system 600 may also employ filter modules to filter notifications based on this additional content that is included in the notifications. Examples of this functionality are illustrated as being employed at the social network service 102 by filter module 602 as well as at the client device 104 as filter module 604. Thus, this functionality may be employed at the social network service 102 and/or the client device 104 to filter the notifications 114. In this way, the notifications 114 may be filtered by the social network service 102 before communication over the network 106. Also, this functionality may be employed at the client device 104, such that the functionality may be employed with legacy social network services 102 that do not employ the filtering techniques described herein. A variety of other examples are also contemplated without departing from the spirit and scope thereof, such as through use by a third-party service.

A variety of different filtering techniques may be employed by the filter modules 602, 604. For example, the filter modules 602, 604 may “filter out” notifications 114 that does not involve interaction on the part of a user of the client device 104. The filter modules 602, 604, for instance, may permit notifications that include the user's login name, real name, and so on. Notifications 114 may also be permitted to “pass through” that are part of conversations that have involved interaction on the part of the user, e.g., a comment, a “like,” a posting of content, an “@” replay in a micro-blog, and so on. Thus, the filter modules 602, 604 may help to present relevant notifications 114 to a user of the client device 104 and thus remove clutter that otherwise might hinder a user's interaction with the social network service 102.

The filter modules 602, 604 may also employ techniques to provide single representations of conversations in a user interface. For example, as notifications are received past notifications that involve a same conversation may be removed from the user interface, further discussion of which may be found in relation to the following figure.

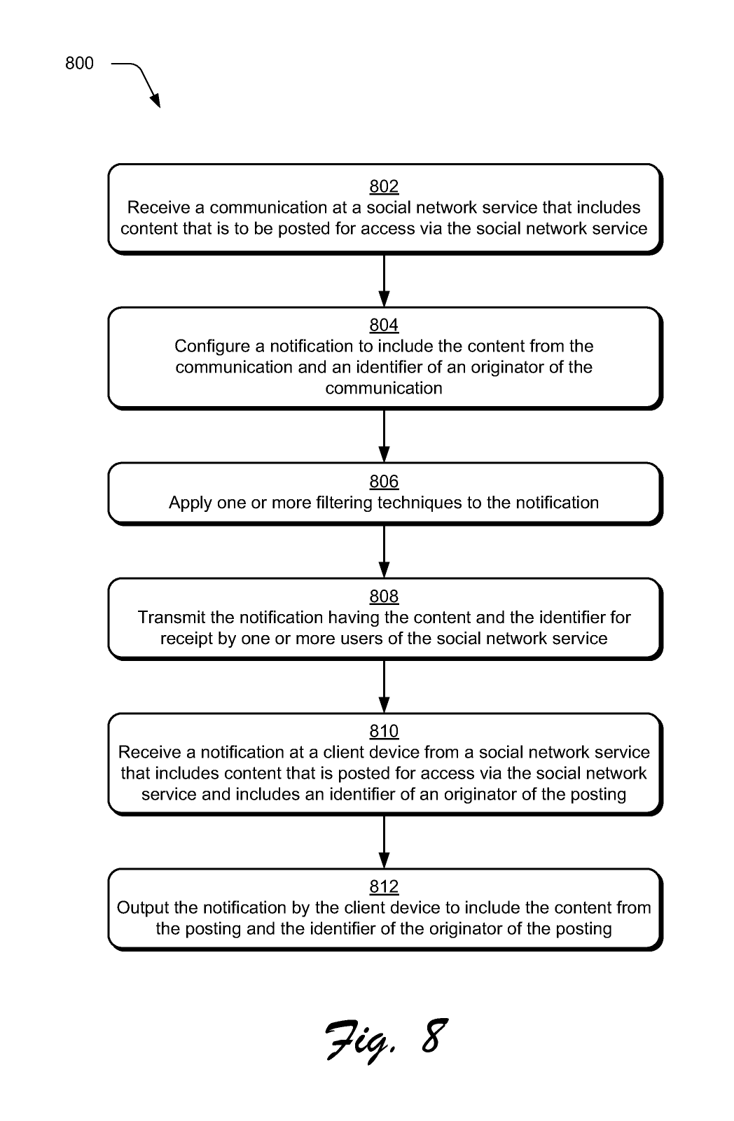

FIG. 7 depicts a system 700 in an example implementation in which a single representation is provided of notifications that involve a matching conversation. The system 700 of FIG. 7 is shown using first and second stages 702, 704. At the first stage 704, a user interface is illustrated that includes notifications 706, 708, 710 received from the social network service 102. Each of the notifications 706, 708, 710 is representative of a single conversation. Thus, when another notification is to be output that pertains to the same conversation, that notification may be output and a previous notification that involves the conversation may be removed.

For example, at the first stage 702 a notification 706 is output by the client device 104 that involves a comment made regarding a photo posted by a user of the client device 104. When another comment is received regarding that photo, the notification 706 is removed from the user interface and replaced by a notification 712 including the most recent comment as shown in the second stage 704.

Additionally, the notification 712 that is used to replace the previous notification 706 may include an indication that other comments are available as previously described, e.g., the “2 comments” text that is included with the notification 712 in the user interface. Thus, the user interface 104 may be uncluttered through use of a single notification to represent a plurality of notifications involved in a matching conversation, further discussion of which may be found in relation to the following procedures.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, the module or functionality represents program code that performs specified tasks when executed on a processor (e.g., CPU or CPUs). The program code can be stored in one or more computer readable memory devices, e.g., memory or other tangible media. The features of the notification techniques described below are platform-independent, meaning that the techniques may be implemented on a variety of commercial computing platforms having a variety of processors.

Example Procedures

The following discussion describes notification techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the example notifications of FIGS. 2-5, and the example systems 600, 700 of FIGS. 6 and 7.

FIG. 8 depicts a procedure 800 in an example implementation in which notification techniques are utilized to provide additional information to a user regarding interaction with a social network service. A communication is received at a social network service that includes content that is to be posted for access via the social network service (block 802). The communication, for instance, may include a status message, something to be “written on a wall,” an image, a link, a media file, a subject of a micro-blog, and so on.

81 A notification is configured to include the content from the communication and an identifier of an originator of the communication (block 804). The notification module 112, for instance, may include content of the communication as well as an identifier of an originator of the communication, such as a user name utilized by the social network service 102.

One or more filtering techniques are applied to the notification (block 806). For example, the social network service 102 may determine that the notifications 114 are to be sent to the client device 104 due to an indication that a user of the client device is a friend of an originator of a communication that initiated the notification. Further, the social network service 102 may employ filtering techniques such that the one or more notifications that are displayed are filtered for display based on a likely relevancy of the notification to the user. This relevancy may be determined in a variety of ways, such as by being part of a conversation with which the user has interacted, mention the user's name, and so on.

The notification having the content and the identifier is transmitted for receipt by one or more users of the social network service (block 808). A notification may then be received at a client device from the social network service that includes content that is posted for access via the social network service and includes an identifier of an originator of the posting (block 810). The notification may then be output by the client device to include the content form the posting and the identifier of the originator of the posting (block 812). Thus, a user of the client device 104 may be readily informed as to an action that initiated formation and transmittal of the notification without initiating another application to navigate to the social network service 102 via the network 106 to obtain this information.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving a notification at a client device from a social network service that includes content that is posted for access via the social network service and includes an identifier of an originator of the posting; and
outputting the notification by the client device to include the content from the posting and the identifier of the originator of the posting.

2. A method as described in claim 1, wherein the notification is configured to include the content for display by the client device without accessing the social network service after receipt of the notification.

3. A method as described in claim 1, wherein the notification is configured to display the content by the client device without initiating an application that is specifically configured to access the social network service.

4. A method as described in claim 1, further comprising grouping related content for representation via a single item in a user interface output by the client device, the single item being selectable to cause display of the related content.

5. A method as described in claim 1, wherein the notification is filtered for relevancy.

6. A method as described in claim 5, wherein the relevancy is based at least in part on whether a user of the client device has expressed interest in particular topic to which the content pertains.

7. A method as described in claim 1, wherein the notification is configured to support a response to an action that caused generation of the notification without switching applications.

8. A method as described in claim 5, wherein the filtering is performed by the client device.

9. A method as described in claim 1, wherein the content is a photo.

10. A method as described in claim 1, wherein the content is text of a status update.

11. A method as described in claim 1, wherein the content is a comment regarding other content that is posted by the social network service.

12. A method as described in claim 1, wherein the content indicates whether the originator likes content previously posted to the social network service.

13. A method implemented by at least one computing device, the method comprising:
receiving a communication at a social network service that includes content that is to be posted for access via the social network service;
configuring a notification to include the content from the communication and an identifier of an originator of the communication; and
transmitting the notification having the content and the identifier for receipt by one or more users of the social network service.

14. A method as described in claim 13, further comprising filtering the notification for relevancy to the one or more users.

15. A method as described in claim 14, wherein the relevancy is based at least in part on whether the one or more users have expressed interest in particular topic to which the content pertains.

16. A method as described in claim 13, wherein the the notification is configured to support a response to an action that caused generation of the notification without switching applications.

17. A method of claim 13, wherein the content is a photo, text of a status update, a comment regarding other content that is posted by the social network service, or indicates whether the originator likes content previously posted to the social network service.

18. A client device comprising one or more modules that are configured to perform operations comprising displaying one or more notifications received from a social network service in a user interface, the notifications sent to the client device due to an indication that a user of the client device is a friend of an originator of a communication that initiated the notification, the one or more notifications that are displayed are filtered for display based on a likely relevancy of the notification to the user.

19. A client device of claim 18, wherein the one or more notifications are filtered based on whether content of the notification references the user.

20. A client device of claim 18, wherein the relevancy is based at least in part on whether the notification references part of a conversation thread with which the user has interacted and the notification includes content posted as part of the thread.
